(19) United States
(12) Patent Application Publication
(10) Pub. No.: US 2022/0335723 A1
(43) Pub. Date: Oct. 20, 2022

(54) MANAGEMENT APPARATUS, MANAGEMENT METHOD, MANAGEMENT SYSTEM, COMPUTER PROGRAM AND RECORDING MEDIUM

(71) Applicant: NEC Corporation, Minato-ku, Tokyo (JP)

(72) Inventors: Yuji Tahara, Tokyo (JP); Mitsunori Morisaki, Tokyo (JP)

(73) Assignee: NEC Corporation, Minato-ku, Tokyo (JP)

(21) Appl. No.: 17/617,063

(22) PCT Filed: Mar. 27, 2020
(86) PCT No.: PCT/JP2020/014116

§ 371 Date: Dec. 7, 2021

(30) Foreign Application Priority Data
Jun. 10, 2019 (JP) 2019-107727

(51) Int. Cl. G06V 20/52; G08B 21/18; G06V 20/40

(52) U.S. Cl. CPC G06V 20/52; G08B 21/18; G06V 20/46

(57) ABSTRACT

A management apparatus manages a target facility to which an optically readable optical information indicating a facility identification information is added. The management apparatus includes: a detection unit that detects the optical information from a first image obtained by imaging the target facility; a determination unit that determines an extraction condition for extracting an extraction image including at least a part of the target facility, on the basis of the first image; and an association unit that associates the facility identification information indicated by the optical information with the determined extraction condition.

### TECHNICAL FIELD

The present invention relates to a management apparatus, a management method, a management system, a computer program, and a recording medium, and, in particular, to a management apparatus, a management method, a management system, a computer program, and a recording medium that remotely manage a target facility.

### BACKGROUND ART

For an apparatus of this type, for example, a crime prevention security system for an unmanned store has been proposed (see Patent Literature 1). Other related techniques include Patent Literatures 2 to 6.

### CITATION LIST

### Patent Literature

Patent Literature 1: JPH10-174089A
Patent Literature 2: JPH10-191309A
Patent Literature 3: JPH10-218617A
Patent Literature 4: JP2000-069455A
Patent Literature 5: JP2006-339982A
Patent Literature 6: International Publication No. WO2016/139940A1

### SUMMARY OF INVENTION

### Technical Problem

When the target facility is remotely managed, as its advance preparation, the target facility needs to be registered in an apparatus (or system) that performs remote management. When the target facility is registered, only an identification information on the target facility, which includes numbers, alphabets, symbols or combinations thereof, for example is registered in many cases. Therefore, a user (i.e., an administrator or a manager) of the apparatus that performs remote management hardly grasps the target facility from the registered identification information, which is technically problematic.

In view of the problems described above, it is therefore an example object of the present invention to provide a management apparatus, management method, a management system, a computer program and a recording medium that are configured to relatively easily grasp the target facility for remote management.

### Solution to Problem

A management apparatus according to an example aspect of the present invention is a management apparatus that manages a target facility to which an optically readable optical information indicating a facility identification information is added, the management apparatus including: a detection unit that detects the optical information from a first image obtained by imaging the target facility; a determination unit that determines an extraction condition for extracting an extraction image including at least a part of the target facility, on the basis of the first image; and an association unit that associates the facility identification information indicated by the optical information with the determined extraction condition.

A management apparatus according to another example aspect of the present invention is a management apparatus that manages a plurality of target facilities to each of which an optically readable optical information indicating a facility identification information is added, the management apparatus including: a state information acquisition unit that obtains a plurality of state informations respectively corresponding to the target facilities, which are detected by a sensor that senses the target facilities; an image acquisition unit that obtains a plurality of captured images including at least a part of the target facilities, which are imaged respectively by a plurality of imaging apparatuses; a detection unit that detects one optical information that is the optical information and that is added to one of the target facilities, from each of the captured images, when an abnormality of a state of the one target facility is detected on the basis of the state informations; an extraction unit that extracts one or more captured images including at least a part of the one target facility from the captured images, on the basis of a result of the detection of the one optical information by the detection unit; and an output unit that outputs the state of the target facility and at least one of the extracted one or more captured images in association with each other.

A management method according to an example aspect of the present invention is a management method that manages a target facility to which an optically readable optical information indicating a facility identification information is added, the management method including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

A computer program according to an example aspect of the present invention is a computer program that allows a computer to execute a management method that manages a target facility to which an optically readable optical information indicating a facility identification information is added, the computer program including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

A recording medium according to an example aspect of the present invention is a recording medium on which a computer program is recorded, the computer program allowing a computer to execute a management method that manages a target facility to which an optically readable optical information indicating a facility identification information is added, the computer program including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

A management system according to an example aspect of the present invention is a management system that manages a target facility to which an optically readable optical information indicating a facility identification information is added, the management system including: a sensor that senses the target facility; an imaging apparatus that images the target facility; and a management apparatus, the management apparatus including: a first acquisition unit that obtains the facility identification information in association with a sensor identification information on the sensor; a detection unit that detects the optical information from a first image obtained by the imaging apparatus imaging the target facility; a determination unit that determines an extraction condition for extracting an extraction image including at least a part of the target facility, on the basis of the first image and the detected optical information; and an association unit that associates the facility identification information with the determined extraction condition.

### Advantageous Effects of Invention

According to the management apparatus in the one aspect and the other aspect described above, and the management method, the management system, the computer program, and the recording medium in the respective example aspects described above, it is possible to relatively easily grasp the target facility for remote management.

### BRIEF DESCRIPTION OF DRAWINGS

FIG. 1 is a diagram illustrating an overview of a remote management system according to a first example embodiment.

FIG. 2 is a block diagram illustrating a hardware configuration of the management apparatus according to the first example embodiment.

FIG. 3 is a block diagram illustrating a functional block implemented in a CPU of the management apparatus according to the first example embodiment.

FIG. 4 is a flowchart illustrating the operation of the management apparatus according to the first example embodiment.

FIG. 5 is a diagram illustrating an example of an extraction range according to the first example embodiment.

FIG. 6 is an example of an image displayed.

FIG. 7 is a block diagram illustrating a functional block implemented in a CPU of a management apparatus according to a second modified example of the first example embodiment.

FIG. 8 is a diagram illustrating an overview of a remote management system according to a second example embodiment.

FIG. 9 is a flowchart illustrating an abnormality detection operation of a management apparatus according to the second example embodiment.

FIG. 10 is another example of the image displayed.

### DESCRIPTION OF EXAMPLE EMBODIMENTS

A management apparatus, a management method, a management system, a computer program and a recording medium according to example embodiments will be described with reference to the drawings.

### First Example Embodiment

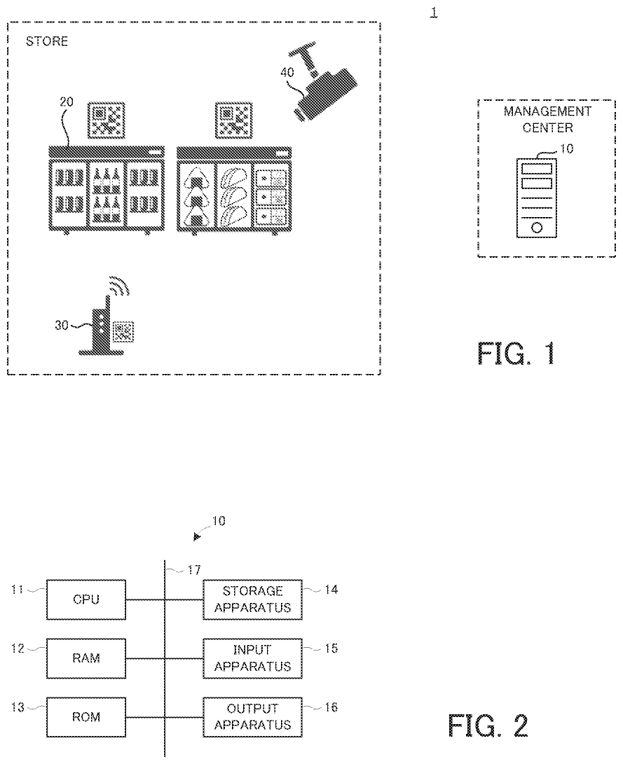

A management apparatus, a management method, a management system, a computer program and a recording medium according to a first example embodiment will be described with reference to FIG. 1 to FIG. 6, by using a remote management system 1 that remotely manages a store.

(Remote Management System)

The remote management system 1 according to the first example embodiment will be described with reference to FIG. 1. FIG. 1 is a diagram illustrating an overview of the remote management system according to the first example embodiment.

In FIG. 1, the remote management system 1 includes: a management apparatus 10 installed in a management center; and a plurality of facilities including a facility 20 as a management target installed in the store. In FIG. 1, the facility 20 is equipped with a sensor 30 even though it is illustrated separately from the facility 20 for convenience. The store is equipped with a monitor camera 40 that is configured to image the facility 20 from the outside.

The sensor 30 and the monitor camera 40 are connected to the management apparatus 10 through a not-illustrated network such as, for example, the Internet. A signal outputted from the sensor 30 and a video signal outputted from the monitor camera 40 are transmitted to the management apparatus 10 through the network.

Here, for convenience of explanation, the management target is limited to the facility 20, but it may be a plurality of facilities. Furthermore, there may be not only one but also a plurality of monitor cameras 40 that are installed.

(Management Facility)

Next, a hardware configuration of the management apparatus 10 will be described with reference to FIG. 2. FIG. 2 is a block diagram illustrating the hardware configuration of the management apparatus 10 according to the first example embodiment.

In FIG. 2, the management apparatus 10 includes a CPU (Central Processing Unit) 11, a RAM (Random Access Memory) 12, a ROM (Read Only Memory) 13, a storage apparatus 14, an input apparatus 15 and an output apparatus 16. The CPU 11, the RAM 12, the ROM 13, the storage apparatus 14, the input apparatus 15, and the output apparatus 16 are interconnected through a data bus 17.

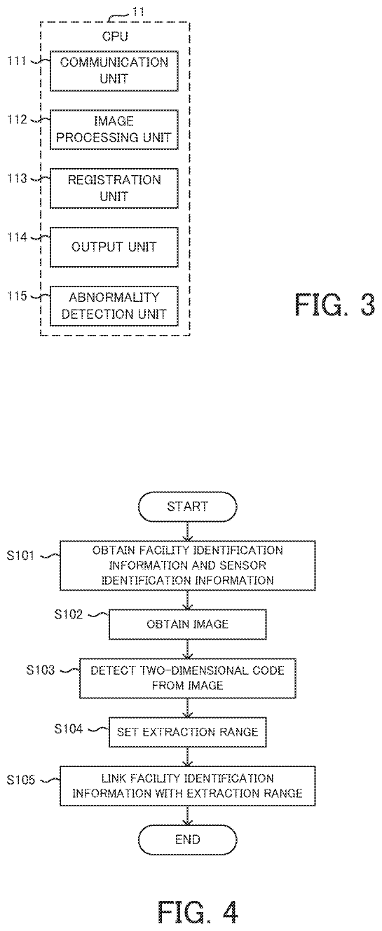

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not-illustrated apparatus disposed outside the management apparatus 10, through a network interface. The CPU 11 controls the RAM 12, the storage apparatus 14, the input apparatus 15, and the output apparatus 16 by executing the read computer program. Especially in the first example embodiment, when the CPU 11 executes the read computer program, a logical functional block(s) for remotely managing the management target (in this case, the facility 20) installed in the store is implemented in the CPU 11. In other words, the CPU 11 is configured to function as a controller for remotely managing the management target. A configuration of the functional block implemented in the CPU 11 will be described in detail later with reference to FIG. 3.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the management apparatus 10. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the management apparatus 10. The input apparatus 15 may include, for example, at least one of a keyboard, a mouse, and a touch panel.

The output apparatus 16 is an apparatus that outputs information about the management apparatus 10 to the outside. For example, the output apparatus 16 may be a display apparatus that is configured to display information about the management apparatus 10.

Next, a configuration of the functional block implemented in the CPU 11 will be described with reference to FIG. 3. FIG. 3 is a block diagram illustrating the function block implemented in the CPU 11 of the management apparatus 10.

As illustrated in FIG. 3, a communication unit 111, an image processing unit 112, a registration unit 113, an output unit 114, and an abnormality detection unit 115 are implemented in the CPU 11 as logical functional blocks.

In the first example embodiment, an explanation will be given mainly to the operation of the communication unit 111, the image processing unit 112, the registration unit 113, the operation of the output unit 114 and the abnormality detection unit 115 when the facility 20 as the management target is newly registered in the management apparatus 10.

On the assumption, an optically readable optical information, such as, for example, a two-dimensional code, is added to the facility 20, wherein an identification information (hereinafter referred to as a “facility identification information” as occasion demands), such as, for example, a manufacturing number of a facility and a store number of a store where the facility is installed, is recorded on the optical information. The optical information is attached, for example, to a top board of the facility 20 such that it can be imaged by the monitor camera 40. The optical information may be attached to any part of an outer surface of the facility 20 as long as it can be imaged by the monitor camera 40.

When the facility 20 is compatible with IoT (Internet of Things), the sensor 30 is built in the facility 20. In this case, an identification information on the sensor 30 (hereinafter referred to as a “sensor identification information” as occasion demands) is specified from a facility identification information on the facility 20. On the other hand, when the facility 20 is not compatible with IoT, the optical information on which the sensor identification information is recorded is added to the sensor 30.

An operator who installs the facility 20 in the store reads the optical information on the facility 20, for example, by using a terminal for work, such as a smartphone. As a result, the facility identification information on the facility 20 is obtained by the terminal for work. When the facility 20 is compatible with IoT, the communication unit 111 of the management apparatus 10 obtains the facility identification information on the facility 20 from the terminal for work through the network.

On the other hand, when the facility 20 is not compatible with IoT, the operator reads the optical information on the sensor 30 attached to the facility 20 and links the facility identification information on the facility 20 with the sensor identification information on the sensor 30. The communication unit 111 of the management apparatus 10 obtains the facility identification information on the facility 20 and the sensor identification information on the sensor 30 that are linked with each other, from the terminal for work, through the network.

Now, the operation of the management apparatus 10 will be described with reference to the flowchart of FIG. 4. In a step S101 in FIG. 4, as described above, the communication unit 111 of the management apparatus 10 obtains the facility identification information and the sensor identification information. The registration unit 113 registers the facility identification information and the sensor identification information in the storage apparatus 14.

When the facility that is the management target is compatible with IoT, the registration unit 113 specifies the sensor identification information from the facility identification information (e.g., specifies the sensor identification information on the sensor 30 from the facility identification information on the facility 20 that is compatible with IoT), and registers the specified facility identification information and the specified sensor identification information in the storage apparatus 14. In this case, the sensor identification information may be specified, for example, from a table indicating a correspondence between the facility identification information and the sensor identification information on a sensor that is built in a facility indicated by the facility identification information. Practically, the registration unit 113 firstly makes a facility list on which the facility identification information on each of the facilities installed in the store and an identification information on the store (e.g., a store number, a store name, etc.) are linked with each other. The facility list is registered (stored) in the storage apparatus 14 (wherein the facility list is made, for example, when each facility is carried into the store). Then, the registration unit 113 links the sensor identification information with one facility included in the facility list (i.e., a facility relating to the facility identification information corresponding to the sensor identification information). As a result, the facility identification information and the sensor identification information are linked with each other and registered in the storage apparatus 14.

In parallel with the step S101, the communication unit 111 receives a video signal from the monitor camera 40, and obtains an image in the store captured by the monitor camera 40 (step S102). The image processing unit 112 detects the optical information (e.g., a two-dimensional code) from the obtained image (step S103). At this time, the image processing unit 112 specifies the facility to be newly registered (here, the facility 20) on the basis of the facility identification information indicated by the detected optical information. When it is hard to obtain the facility identification information from the optical information, for example, due to distortion of the optical information in the image or the like, then, the image processing unit 112 may perform predetermined image processing, such as, for example, distortion correction, on the image.

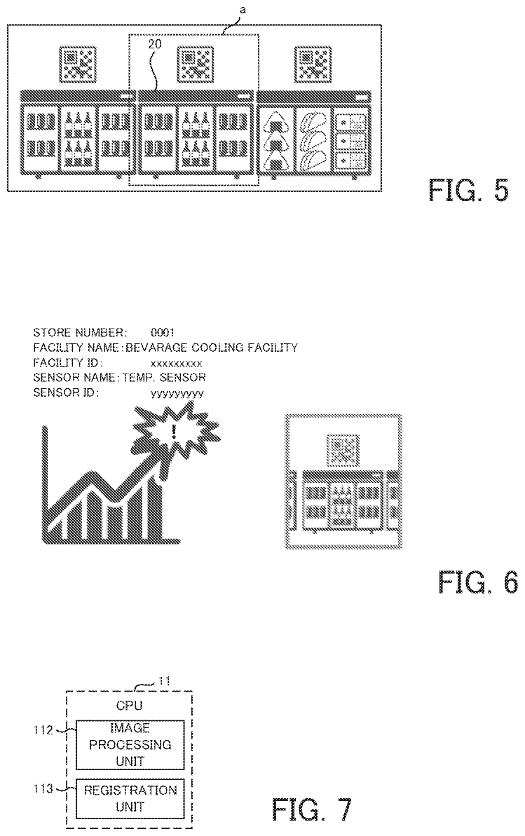

Then, the image processing unit 112 sets a range in which the facility to be newly registered (here, the facility 20) is supposed to be included in the image, as an extraction range (step S104). Here, the extraction range may be set, for example, on the basis of a position of the optical information in the image (i.e., image coordinates), a size of the facility in the image that is estimated from an installation position and optical characteristics of the monitor camera 40, and the like. As illustrated in FIG. 5, for example, regarding the facility 20, the extraction range may be set as illustrated by a dotted line frame a.

Then, the registration unit 113 links the facility identification information indicated by the optical information detected from the image with the set extraction range (step S105). As a result, the registration of the facility to be newly registered (here, the facility 20) to the management apparatus 10 is completed.

After the facility 20 is registered in the management apparatus 10, the image processing unit 112 extracts an image corresponding to the extraction range from the image in the store captured by the monitor camera 40 obtained via the communication unit 111. The output unit 114 specifies the sensor identification information linked with the facility identification information on the basis of the facility identification information linked with the extraction range of the image extracted by the image processing unit 112. The output unit 114 obtains a signal outputted from the sensor 30 corresponding to the specified sensor identification information, via the communication unit 111. The output unit 114 controls the output apparatus 16 to display a state (e.g., temperature, etc.) of the facility 20 based on a state information indicated by the signal outputted from the sensor 30, and to display the extracted image. As a result, for example, such an image as illustrated in FIG. 6 is displayed on the output apparatus 16.

The abnormality detection unit 115 determines whether or not the state of the facility 20 is abnormal on the basis of the state information indicated by the signal outputted from the sensor 30. When it is determined by the abnormality detection unit 115 that the state of the facility 20 is abnormal, the output unit 114 controls the output apparatus 16 to give a warning. At this time, the output unit 114 may control the output apparatus 16, for example, to display an exclamation mark (exclamation point) (see FIG. 6). The output 114 may control the output apparatus 16 to output an auditory information, such as, for example, an alarm sound, in place of or in addition to a visual information as a warning. The output unit 114 may further give a warning to an apparatus that is different from the management apparatus 10, such as, for example, a not-illustrated store terminal installed in a store and a not-illustrated mobile terminal carried by a clerk or the like who works in the store. Incidentally, when it is determined by the abnormality detection unit 115 that the state of the facility 20 is not abnormal, the output unit 114 may control the output apparatus 16 to give such a notice that the facility 20 is normal.

The “communication unit 111” corresponds to an example of the “first acquisition unit” and the “second acquisition unit” in Supplementary Note described later. The “image processing unit 112” corresponds to an example of the “detection unit” and the “determination unit” in Supplementary Note described later. The “registration unit 113”, the “output unit 114”, and the “abnormality detection unit 115” respectively correspond to examples of the “association unit”, the “output unit”, and the “abnormality detection unit” in Supplementary Note described later.

### Technical Effect

In the first example embodiment, the extraction range of the image is linked with the facility identification information on the facility that is the management target. Therefore, the management apparatus 10 is allowed to present an image in which the facility that is the management target is included, together with the facility identification information, to the user of the management apparatus 10. As a result, the user of the management apparatus 10 can relatively easily grasp the target facility for remote management.

### First Modified Example

In the step S104 described above, other conditions may be set in addition to or in place of the extraction range. The image processing unit 112 may set a condition for the monitor camera 40, for example, on the basis of how the optical information is captured in the image. Specifically, for example, the image processing unit 112 may set a condition for the angle of view, focal distance, or zoom magnification (when the monitor camera 40 has a zoom function) of the monitor camera 40, or a condition for an optical axis direction (when the monitor camera 40 has a swing function), on the basis of the position of the optical information in the image. Alternatively, the image processing unit 112 may set a condition for the angle of view, or focal distance, or zoom magnification of the monitor camera 40, or a condition for resolution (when the monitor camera 40 has a zoom function), on the basis of the size of the optical information in the image.

Alternatively, the image processing unit 112 may not simply trim a predetermined part from the image captured by the monitor camera 40, but may perform distortion correction processing on the predetermined part after trimming the predetermined portion to obtain (extract) the image of interest. In this case, the image processing unit 112 may set a prior information (e.g., coordinates of the predetermined part, etc.) for trimming the predetermined part from the image captured by the monitor camera 40.

Furthermore, if there are a plurality of monitor cameras 40 installed in the store, the image processing unit 112 may set one or more monitor cameras 40 that should image the facility to be newly registered (here, the facility 20), on the basis of how the optical information is captured in each of images respectively captured by the monitor cameras 40. In this case, for example, the facility to be newly registered and information about one or more monitor cameras 40 that should image the facility may be linked with each other and may be registered on the facility list on which the facility identification information on each of the facilities installed in the store and the identification information on the store (e.g., a store number, a store name, etc.) are linked with each other, or, on a table on which the facility identification information created on the basis of the facility list is linked with the information about one or more monitor cameras 40 that should image the facility.

Incidentally, the extraction range, the condition for the angle of view, focal distance, or zoom magnification of the monitor camera 40, the condition for the optical axis direction, the conditions for the resolution, and the information indicating one or more monitor cameras 40 that should image the facility to be newly registered (e.g., the identification information on the monitor camera 40) are an example of the “extraction condition” in Supplementary Note described later.

### Second Modified Example

When the management apparatus 10 includes one or more CPUs other than the CPU 11, or when the management center includes a plurality of management apparatuses 10, the image processing unit 112 and the registration unit 113 are implemented in the CPU 11 of the management apparatus 10 as illustrated in FIG. 7, whereas the function blocks other than the image processing unit 112 and the registration unit 113 may not be implemented.

### Second Example Embodiment

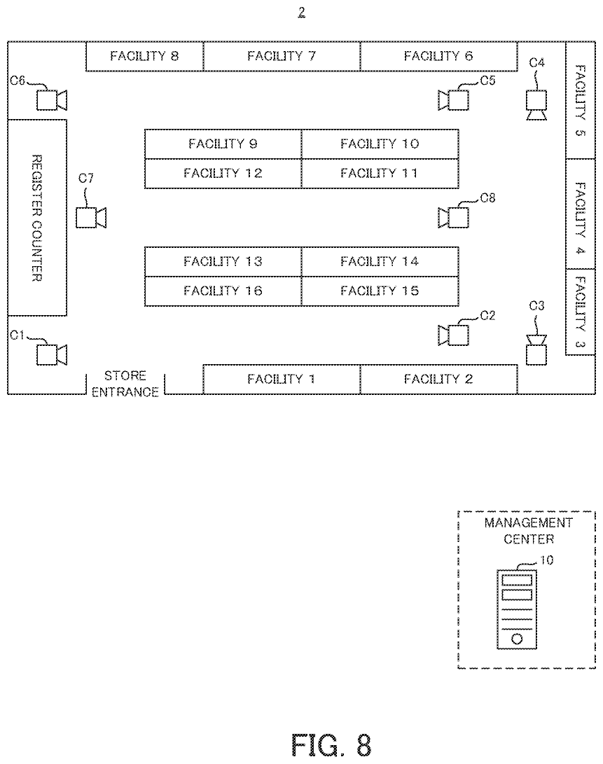

A management apparatus, a management method, a management system, a computer program, and a recording medium according to a second example embodiment will be described with reference to FIG. 8 to FIG. 10 by using a remote management system 2 that remotely manages a store. The second example embodiment is the same as the first example embodiment described above, except that it is assumed that a plurality of monitor cameras are installed in the store. Therefore, in the second example embodiment, the description that overlaps with that of the first example embodiment will be omitted, and the same parts on the drawings will be denoted by the same reference numerals. Basically, different points will be described with reference to FIG. 8 to FIG. 10.

In FIG. 8, the remote management system 2 includes the management apparatus 10 installed in the management center; facilities 1 to 16 as the management target installed in the store; and monitor cameras C1 to C8 that are configured to image the facilities 1 to 16 from the outside. Each of the facilities 1 to 16 is equipped with a not-illustrated sensor. The arrangement and the number of the monitor cameras C1 to C8 in FIG. 8 are exemplary, and are not limited to this example. Similarly, the arrangement and the number of the facilities 1 to 16 are exemplary, and are not limited to this example.

It is assumed that the facility identification information corresponding to each of the facilities 1 to 16 and the sensor identification information on the sensor installed in each of the facilities 1 to 16 are registered in the storage apparatus 14 (see FIG. 2) in association with each other.

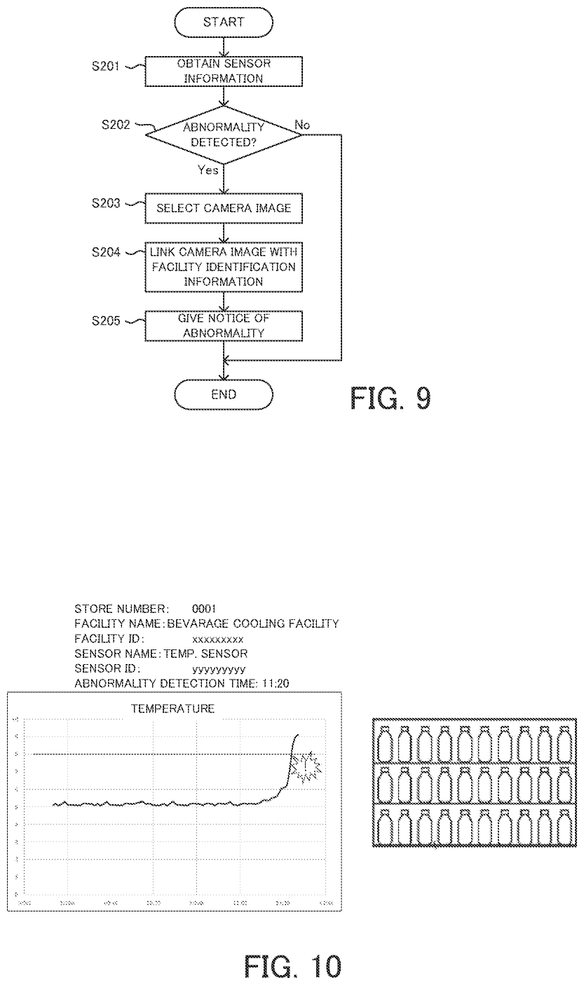

Especially in the second example embodiment, the operation of the management apparatus 10 when an abnormality of the facility is detected by the abnormality detection unit 115 of the management apparatus 10 will be described with reference to a flowchart in FIG. 9.

In FIG. 9, the abnormality detection unit 115 obtains a signal outputted from each of the sensors respectively installed in the facilities 1 to 16, via the communication unit 111. As a result, the abnormality detection unit 115 obtains the state information indicated by the signal outputted from each of the sensors (step S201).

Then, the abnormality detection unit 115 determines whether or not there is an abnormality in at least one of the facilities 1 to 16 on the basis of the state information obtained in the step S201 (step S202). In the step S202, when it is determined that any of the facilities 1 to 16 has no abnormality (the step S202: No), the operation illustrated in FIG. 9 is ended. Then, after a lapse of a predetermined time (e.g., several tens of milliseconds to several hundred milliseconds), the step S201 is performed again. That is, the operation illustrated in FIG. 9 is repeatedly performed at a cycle corresponding to the predetermined time.

In the step S202, when it is determined that at least one of the facilities 1 to 16 has an abnormality (the step S202: Yes), the image processing unit 112 obtains a plurality of camera images respectively captured by the monitor cameras C1 to C8, via the communication unit 111. Subsequently, the image processing unit 112 detects the optical information from the obtained camera images.

Then, on the basis of the facility identification information indicated by the detected optical information, the image processing unit 112 specifies one or more camera images that includes the optical information corresponding to the facility identification information on the facility that is determined to have an abnormality. Incidentally, if there is a table on which the facility identification information on each of the facilities 1 to 16 is linked with the monitor camera that is configured to image each of the facilities 1 to 16 (at least one of the monitor cameras C1 to C8), one or more camera images that includes the optical information corresponding to the facility identification information on the facility that is determined to have an abnormality may be specified from the table. Subsequently, the image processing unit 112 selects the camera image that is to be presented to the user of the management apparatus 10, for example, on the basis of the position of the optical information in the specified one or more camera images (i.e., the image coordinates), the size of the optical information, and the like (step S203).

Then, the registration unit 113 associates the camera image selected in the step S203 with the facility identification information on the facility that is determined to have an abnormality, and registers it in the storage apparatus 14 (step S204). In parallel with the step S204, the output unit 114 controls the output apparatus 16 to display the state of the facility (e.g., temperature, etc.) based on the state information indicated by the signal outputted from the sensor related to the sensor identification information associated with the facility identification information on the facility that is determined to have an abnormality, to display the camera image selected in the step S204, and to give a warning (step S205). As a result, for example, an image as illustrated in FIG. 10 is displayed on the output apparatus 16.

In the step S203 described above, when there are a plurality of specified camera images that includes the optical information corresponding to the facility identification information on the facility that is determined to have an abnormality, the image processing unit 112 may select all the specified camera images, as the camera image that is to be presented to the user of the management apparatus 10. At this time, the image processing unit 112 may determine the camera image that is to be preferentially presented to the user of the management apparatus 10 (i.e., the priority of each of the specified camera images may be determined), on the basis of how the optical information is captured in the specified camera images (e.g., the position, the size, or the like of the optical information in the camera image).

In the step S203 described above, the image processing unit 112 obtains a video including a plurality of temporally continuous images captured by the monitor camera that captures the camera image that includes the optical information corresponding to the facility identification information on the facility that is determined to have an abnormality. Then, from the obtained video, the image processing unit 112 may extract a video for a predetermined time (e.g., several seconds to several tens of seconds, etc.) including a time point at which it is determined by the abnormality detection unit 115 that there in the storage apparatus 14 in association with the facility identification information on the facility that is determined to have an abnormality. The output unit 114 may control the output apparatus 16 to display the extracted video in addition to or in place of the camera image (i.e., a still image) in the step S205 described above. Furthermore, one image (i.e., a still image) may be extracted from the extracted video, and the extracted one image may be displayed in addition to the extracted video.

In the step S205 described above, a warning may be given to an apparatus that is different from the management apparatus 10, such as, for example, a not-illustrated store terminal installed in the store and a not-illustrated mobile terminal carried by a clerk or the like who works in the store.

<Supplementary Note>

With respect to the example embodiments described above, the following Supplementary Notes will be further disclosed.

(Supplementary Note 1)

A management apparatus according to Supplementary Note 1 is a management apparatus that manages a target facility to which an optically readable optical information indicating a facility identification information is added, the management apparatus including: a detection unit that detects the optical information from a first image obtained by imaging the target facility; a determination unit that determines an extraction condition for extracting an extraction image including at least a part of the target facility, on the basis of the first image; and an association unit that associates the facility identification information indicated by the optical information with the determined extraction condition.

(Supplementary Note 2)

A management apparatus described in Supplementary Note 2 is the management apparatus described in Supplementary Note 1, wherein the determination unit determines an extraction range including at least a part of the target facility as at least a part of the extraction condition, on the basis of a position of the optical information in the first image.

(Supplementary Note 3)

A management apparatus described in Supplementary Note 3 is the management apparatus described in Supplementary Note 1, wherein the detection unit detects the optical information from a plurality of captured images, which are the first images, respectively imaged by a plurality of imaging apparatuses, and the determination unit determines an imaging apparatus that images the target facility as at least a part of the extraction condition, on the basis of the plurality of captured images and a result of the detection by the detection unit.

(Supplementary Note 4)

A management apparatus described in Supplementary Note 4 is the management apparatus described in any one of Supplementary Notes 1 to 3, further including a first acquisition unit that obtains a sensor identification information on a sensor that senses the target facility in association with the facility identification information.

(Supplementary Note 5)

A management apparatus described in Supplementary Note 5 is the management apparatus described in Supplementary Note 4, further including: a second acquisition unit that obtains a state information on the target facility detected by the sensor and a second image obtained by imaging the target facility; and an output unit that outputs a state of the target facility based on the state information and an extraction image extracted from the second image on the basis of the determined extraction condition in association with each other.

(Supplementary Note 6)

A management apparatus described in Supplementary Note 6 is the management apparatus described in any one of Supplementary Notes 1 to 3, further including: a second acquisition unit that obtains a state information on the target facility detected by a sensor that senses the target facility and a second image obtained by imaging the target facility; and an output unit that outputs a state of the target facility based on the state information and an extraction image extracted from the second image on the basis of the determined extraction condition in association with each other when the state is abnormal.

(Supplementary Note 7)

A management apparatus described in Supplementary Note 7 is the management apparatus described in Supplementary Note 5 or 6, wherein the output unit gives a warning when the state is abnormal.

(Supplementary Note 8)

A management apparatus described in Supplementary Note 8 is the management apparatus described in any one of Supplementary Notes 5 to 7, further including an abnormality detection unit that detects an abnormality in the state of the target facility on the basis of the state information on the target facility detected by the sensor.

(Supplementary Note 9)

A management method described in Supplementary Note 9 is a management method that manages a target facility to which an optically readable optical information indicating a facility identification information is added, the management method including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

(Supplementary Note 10)

A computer program described in Supplementary Note 10 is a computer program that allows a computer to execute a management method that manages a target facility to which an optically readable optical information indicating a facility identification information is added, the computer program including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

(Supplementary Note 11)

A recording medium described in Supplementary Note 11 is a recording medium on which a computer program is recorded, the computer program allowing a computer to execute a management method that manages a target facility to which an optically readable optical information indicating a facility identification information is added, the computer program including: detecting the optical information from a first image obtained by imaging the target facility; determining an extraction condition for extracting an extraction image including at least a part of the target facility, on the basis of the first image; and associating the facility identification information indicated by the optical information with the determined extraction condition.

(Supplementary Note 12)

A management system described in Supplementary Note 12 is a management system that manages a target facility to which an optically readable optical information indicating a facility identification information is added, the management system including: a sensor that senses the target facility; an imaging apparatus that images the target facility; and a management apparatus, the management apparatus including: a first acquisition unit that obtains the facility identification information in association with a sensor identification information on the sensor; a detection unit that detects the optical information from a first image obtained by the imaging apparatus imaging the target facility; a determination unit that determines an extraction condition for extracting an extraction image including at least a part of the target facility, on the basis of the first image and the detected optical information; and an association unit that associates the facility identification information with the determined extraction condition.

(Supplementary Note 13)

A management apparatus described in Supplementary Note 13 is a management apparatus that manages a plurality of target facilities to each of which an optically readable optical information indicating a facility identification information is added, the management apparatus including: a state information acquisition unit that obtains a plurality of state informations respectively corresponding to the plurality of target facilities, which are detected by a sensor that senses the target facilities; an image acquisition unit that obtains a plurality of captured images including at least a part of the plurality of target facilities, which are imaged respectively by a plurality of imaging apparatuses; a detection unit that detects one optical information that is the optical information and that is added to one of the plurality of target facilities, from each of the captured images, when an abnormality of a state of the one target facility is detected on the basis of the plurality of state informations; an extraction unit that extracts one or more captured images including at least a part of the one target facility from the plurality of captured images, on the basis of a result of the detection of the one optical information by the detection unit; and an output unit that outputs the state of the one target facility and at least one of the extracted one or more captured images in association with each other.

(Supplementary Note 14)

A management apparatus described in Supplementary Note 14 is the management apparatus described in Supplementary Note 13, wherein when a plurality of captured images including at least a part of the one target facility are extracted by the extraction unit, the output unit outputs the state of the one target facility and the extracted captured images in association with each other.

(Supplementary Note 15)

A management apparatus described in Supplementary Note 15 is the management apparatus described in Supplementary Note 13, wherein when a plurality of captured images including at least a part of the one target facility are extracted by the extraction unit, the output unit determines a captured image to be outputted in association with the state of the one target facility on the basis of how the one optical information is captured in each of the extracted captured images.

(Supplementary Note 16)

A management apparatus described in Supplementary Note 16 is the management apparatus described in any one of Supplementary Notes 13 to 15, wherein the extraction unit specifies one or more imaging apparatuses that capture the extracted one or more captured images from the plurality of imaging apparatuses, and extracts a video for a predetermined period including a time point at which the abnormality of the state of the one target facility is detected from a video including a plurality of temporally continuous captured images captured by the specified one or more imaging apparatuses, and the output unit outputs the extracted video in association with the state of the one target facility, in place of or in addition to at least one of the extracted one or more captured images.

The present invention is not limited to the examples described above and is allowed to be changed, if desired, without departing from the essence or spirit of the invention which can be read from the claims and the entire specification. A management apparatus, a management method, a management system, a computer program and a recording medium, which involve such changes, are also intended to be within the technical scope of the present invention.

This application is based upon and claims the benefit of priority from Japanese Patent Application No. 2019-107727, filed on Jun. 10, 2019, the disclosure of which is incorporated herein in its entirety by reference.

### DESCRIPTION OF REFERENCE CODES

1, 2 . . . Remote management system, 10 . . . Management apparatus, 20 . . . Facility, 30 . . . Sensor, 40, C1 to C8 . . . Monitor camera, 111 . . . Communication unit, 112 . . . Image processing unit, 113 . . . Registration unit, 114 . . . Output unit, 115 . . . Abnormality detection unit

What is claimed is:

1. A management apparatus that manages a target facility to which an optically readable optical information indicating a facility identification information is added,
the management apparatus comprising a controller,
the controller being programmed to:
detect the optical information from a first image obtained by imaging the target facility;
determine an extraction condition for extracting an extraction image including at least a part of the target facility, on the basis of the first image; and
associate the facility identification information indicated by the optical information with the determined extraction condition.

2. The management apparatus according to claim 1, wherein
the controller is programmed to determine an extraction range including at least a part of the target facility as at least a part of the extraction condition, on the basis of a position of the optical information in the first image.

3. The management apparatus according to claim 1, wherein
the controller is programmed to detect the optical information from a plurality of captured images, which are the first images, respectively imaged by a plurality of imaging apparatuses, and
the controller is programmed to determine an imaging apparatus that images the target facility as at least a part of the extraction condition, on the basis of the plurality of captured images and a result of the detection by the controller.

4. The management apparatus according to claim 1, wherein
the controller is further programmed to obtain a sensor identification information on a sensor that senses the target facility in association with the facility identification information.

5. The management apparatus according to claim 4, wherein
the controller is further programmed to:
obtain a state information on the target facility detected by the sensor and a second image obtained by imaging the target facility; and
output a state of the target facility based on the state information and an extraction image extracted from the second image on the basis of the determined extraction condition in association with each other.

6. The management apparatus according to claim 1, wherein
the controller is programmed to:
obtain a state information on the target facility detected by a sensor that senses the target facility and a second image obtained by imaging the target facility; and
output a state of the target facility based on the state information and an extraction image extracted from the second image on the basis of the determined extraction condition in association with each other when the state is abnormal.

7. The management apparatus according to claim 5, wherein
the controller is programmed to give a warning when the state is abnormal.

8. The management apparatus according to claim 5, wherein
the controller is further programmed to detect an abnormality in the state of the target facility on the basis of the state information on the target facility detected by the sensor.

9.-11. (canceled)

12. A management system that manages a target facility to which an optically readable optical information indicating a facility identification information is added, the management system comprising:
a sensor that senses the target facility;
an imaging apparatus that images the target facility; and
a management apparatus,
the management apparatus including a controller,
the controller being programmed to:
obtain the facility identification information in association with a sensor identification information on the sensor;
detect the optical information from a first image obtained by the imaging apparatus imaging the target facility;
determine an extraction condition for extracting an extraction image including at least a part of the target facility, on the basis of the first image and the detected optical information; and
associate the facility identification information with the determined extraction condition.

13. A management apparatus that manages a plurality of target facilities to each of which an optically readable optical information indicating a facility identification information is added,
the management apparatus comprising a controller,
the controller being programmed to:
obtain a plurality of state informations respectively corresponding to the plurality of target facilities, which are detected by a sensor that senses the target facilities;
obtain a plurality of captured images including at least a part of the plurality of target facilities, which are imaged respectively by a plurality of imaging apparatuses;
detect one optical information that is the optical information and that is added to one of the plurality of target facilities, from each of the captured images, when an abnormality of a state of the one target facility is detected on the basis of the plurality of state informations;
extract one or more captured images including at least a part of the one target facility from the plurality of captured images, on the basis of a result of the detection of the one optical information by the controller; and
output the state of the one target facility and at least one of the extracted one or more captured images in association with each other.

14. The management apparatus according to claim 13, wherein
when a plurality of captured images including at least a part of the one target facility are extracted by the controller, the controller is programmed to output the state of the one target facility and the extracted captured images in association with each other.

15. The management apparatus according to claim 13, wherein when when a plurality of captured images including at least a part of the one target facility are extracted by the controller, the controller is programmed to determine a captured image to be outputted in association with the state of the one target facility on the basis of how the one optical information is captured in each of the extracted captured images.

16. The management apparatus according to claim 13, wherein
the controller is programmed to specify one or more imaging apparatuses that capture the extracted one or more captured images from the plurality of imaging apparatuses, and extract a video for a predetermined period including a time point at which the abnormality of the state of the one target facility is detected from a video including a plurality of temporally continuous captured images captured by the specified one or more imaging apparatuses, and
the controller is programmed to output the extracted video in association with the state of the one target facility, in place of or in addition to at least one of the extracted one or more captured images.
